(19) United States
(12) Patent Application Publication
(10) Pub. No.: US 2008/0171110 A1
(43) Pub. Date: Jul. 17, 2008

(54) SOLIDS PACKAGE

(76) Inventor: Geoffrey Catherwood Stuart, Faulconbridge (AU)

Correspondence Address: Bryan P. Stanley;Sonnenschein Nath & Rosenthal LLP, Wacker Drive Station, Sears Tower, P.O. Box #061080, Chicago, IL, 60606-1080, US

(21) Appl. No.: 11/624,027

(22) Filed: Jan. 17, 2007

(51) Int. Cl. B65B 29/02; A23F 3/00; A23F 5/00; B65D 85/00; A23L 1/22

(52) U.S. Cl. 426/82; 206/5; 239/1; 222/1

(57) ABSTRACT

A solids package 10 comprises a linear elongate tubular structure 15 which is sealed at an upper end 11 and a lower end 12 thereof, the structure including an integral gripping portion 14 proximate the upper end and a foraminous portion 16, a predetermined amount of a solid material contained within the tubular structure 15, the solid material having a particle size greater then the openings in the foraminous portion, the structure having sufficient overall rigidity so as to permit at least the foraminous portion to be immersed in a liquid and by holding the gripping portion 14, stirring the package so as to cause the solid material to be dispersed, dissolved or infused into the liquid.

### FIELD OF THE INVENTION

The present application relates to a package for containing solid materials. In particular, the present application is directed to a package for containing solid materials in which immersion of the package in a liquid causes the solid materials to be dissolved, dispersed, diffused or infused into the liquid without requiring the package to be opened.

### BACKGROUND OF THE INVENTION

Currently instant coffee is dispensed from a canister or bottle using a spoon to measure the amount of coffee required, and then tipping this spooned instant coffee into a cup. In many cases major or minor spillage will occur; the amount of coffee will vary from spoon to spoon, user to user; and cross contamination may occur when users utilise wet spoons, or contaminate sugar and milk into the coffee being sourced.

Alternatively, users may utilise “stick pack” containers. Stick pack containers are tubular packages adapted to contain a variety of solid, semi-solid and liquid materials. The materials contained in these packages are sealed therein and are dispensed by opening a perforated or soft section of the package. Depending on the nature of the contained material, the contents may then be poured, squeezed or shaken out of the package and into a cup or other vessel.

Typically when stick packs are used to contain coffee, the coffee is poured from the package after opening into a cup to which hot water is added.

Unfortunately, a significant problem associated with stick packs is that the perforated or soft section invariably does not function as well as expected. Often additional force is required, or the use of cutting implements such as scissors or knives to cut the top of the stick pack sachet to enable the contents to be poured from the sachet.

It will also be appreciated that when using a stick pack to dispense coffee, a spoon will still be required to agitate the coffee sufficiently to dissolve it.

In situations where large numbers of persons are being served with coffee, such as in the catering industry, whilst dispensing stick packs assist in the sense of providing the requisite quantity of coffee per person, the stick packs still need to be opened and stirring implements provided for each person. This results in a relatively time consuming, slow and messy process.

Further, in the vending machine market, providing hot drinks such as coffee currently involves complicated and often unreliable mixing of solid and liquid components. The present invention simplifies the dispensing of such hot drinks, by separating the solid component and the hot water, thus enabling the vending machine user to mix their own beverage without the need for a spoon or other stirring device. This provides benefits to both the end user, as well as the vending machine operator, simplifying the vending machine design and adding greater reliability and quality delivery.

The present inventor has recognised the shortcomings of such sealed stick packs and other packaging types for containing and dispensing a predetermined amount of a solid. The invention disclosed herein seeks to provide a solids package that functions both to contain the solid and provide a means by which the solids may be readily dissolved, dispersed, infused or diffused into a liquid. Further it acts as a portion-control and/or single serve package, dispensing a consistent, pre-determined quantity of the solid material.

In reading this specification it should be noted that any discussion of documents, acts, materials, devices, articles or the like which has been included is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to a first aspect, the present invention is a solids package comprising a linear elongate tubular structure which is sealed at an upper end and a lower end thereof, the structure including an integral gripping portion proximate the upper end and a foraminous portion, a predetermined amount of a solid material contained within the tubular structure, the solid material having a particle size greater then the openings in the foraminous portion, the structure having sufficient overall rigidity so as to permit at least the foraminous portion to be immersed in a liquid and by holding the gripping portion, stirring the package so as to cause the solid material to be dispersed, dissolved, diffused or infused into the liquid.

According to a second aspect, the present invention is a method of dissolving, dispersing, infusing or diffusing a predetermined amount of a solid material by immersing a package comprising a linear elongate tubular structure which is sealed at an upper end and a lower end thereof, the structure including an integral gripping portion proximate the upper end and a foraminous portion, the solid material contained within the tubular structure, the solid material having a particle size greater then the openings in the foraminous portion, in liquid to an extent sufficient so that the foraminous portion is in contact with the liquid, applying a stirring force to the gripping portion for a time sufficient for the solid material to be dissolved, dispersed or infused into the liquid, the structure retaining overall rigidity during the application of the stirring force.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The present invention has a number of advantages over conventional packaging, especially for products such as coffee. In particular, it avoids the problem of the opening of conventional packages, especially stick packages, in order to discharge the contents for use. This is so because when a package of the invention containing coffee is placed in a cup containing hot water, the water will enter into the package through the foraminous portion, whereby the coffee is dissolved. Stirring of the package will ensure that the coffee is evenly distributed to form a beverage. Moreover, milk or cream and/or sugar may be added and stirred into the beverage using the package. Alternatively milk or cream in dry powder form, sugar and artificial sweeteners may form part of the solid material inside the package. For example, coffee plus creamer, coffee plus sugar or sweetener, plus creamer/milk powder.

Coffee, if in freeze-dried or spray-dried form tends to dissolve more slowly then powdered instant coffees. In practice this means that undissolved granules may remain in the cup, particularly adhering to the sides and becoming quite unsightly. The package of the present invention avoids this problem as any undissolved granules will tend to be retained in the package. In this sense, the foraminous portion acts as a kind of filter.

By eliminating the use of a spoon to stir the coffee, the cross contamination of sugar with coffee and vice versa is avoided. This is a universal problem where bulk containers of coffee and sugar are provided for use, such as in cafeterias, office and factory canteens, staff kitchens, managed events, seminars and the like. It will also be evident that the problem of wet spoons being placed back into the bulk coffee container, thereby tending to spoil the coffee is entirely avoided. In countries where Occupational Health and Safety laws are in place, this eliminates many of these cross-contamination issues.

In pharmaceutical applications, it permits the ready administration of an accurate measured amount of an active ingredient. This is particularly relevant for senior persons and those suffering for example, from arthritis and rheumatic disorders that restrict the ability to open packages. It is also relevant in administering soluble pharmaceuticals to children. The invention thus becomes an alternative to soluble pharmaceuticals that are currently administered in pill or tablet form.

Finally, it will be recognised that the package of the invention is tamper evident.

### DETAILED DESCRIPTION OF THE INVENTION

The linearly elongate tubular structure will generally be pillow-shaped in appearance. The upper sealed end and the lower sealed end (end-seals) constituting the ends of the pillow, and the fin-seal or lap-seal the closure of the two sides. It will, however, be appreciated that other shapes may be used with the dimensions being determined by the nature of the solid material contained therein.

Sealing of the end-seal, lap-seal or fin-seal may be accomplished by sonic welding, heat, pressure, the use of adhesives or combinations thereof. When the tubular structure is formed from a plastic printing web, including plastic flexible web sheet laminates, sealing will occur through the use of heat and pressure. In such embodiments, it will be usual for the printing web to be slit or cut into specific widths of material to create a single package and this single package will then include a longitudinally extending seam (either lap-seal of fin-seal) comprising the sides of the slit web drawn together and sealed with heat and pressure. Particularly preferred for use in this invention are laminates which comprise plastic materials in combination with a layer of aluminium, but other flexible packaging materials may also be used, as appropriate for the solids inside the package.

A specific example of a suitable packaging material is bi-axially orientated polypropylene (BOPP). This material consists of laminate layers of polypropylene/aluminium/polypropylene.

Proximate the upper end of the tubular structure is a gripping portion which will usually be distinct from the foraminous portion. In some embodiments, printed material, such as advertising and branding may be included in this portion.

Below the gripping portion, there is formed a foraminous portion of the tubular structure. The foraminous portion may extend completely around the tubular structure. In those embodiments in which a web is formed into the tubular structure by heat sealing, thereby introducing a longitudinally extending seam (as a fin-seal or lap-seal), generally the region adjacent the seam will be non-foraminous in character.

It will be appreciated that the extent of the foraminous portion will be determined by nature of the solid material contained in the package, the rate required to dissolve, disperse, diffuse or infuse the solid material and the size of the openings. The pattern of the openings may also be important.

Of course, in order to retain the solid material in the package of the invention, the size of the openings must be less then the particle size of the solid material. Otherwise, it would be possible for the solid material to migrate from the package prior to use.

For guidance, it has been found that a foraminous portion comprising about 500 to 1500 openings, preferably about 1100 to 1200 openings, each opening being in the range of about 0.2 to about 3.0 mm is effective. Such opening sizes allow for the ready penetration of water into the package whilst ensuring that granular materials such as freeze-dried or spray-dried coffee are retained therein. Typically when such coffee granules are 1.0 to 2.0 mm in size, the openings will be about 0.4 mm to about 0.5 mm. The optimum opening size and number may be readily determined for each solid material and liquid in which a package is immersed.

The rate of openings per unit area will vary depending upon factors such as the size of the openings, the spacing between the openings, the pattern of the openings and the nature of the material used to form the foraminous portion.

For guidance, if 2 mm openings are used, with 1 mm spacing between adjacent openings, there would be about 9 openings per cm². Using 1 mm openings with 1 mm spacing results in about 25 openings per cm². Using 0.5 mm openings with 1 mm spacing results in about 100 openings per cm².

The importance of the material used to form the foraminous portion is relevant because if the space between openings is too small, it may cause the foraminous portion to split or tear.

In relation to the pattern of the openings, it will be appreciated that typically such patterns are formed by creating defined parts in the foraminous portion have the requisite pattern. The spacing and arrangement of such defined parts determines the overall pattern in the foraminous portion.

It is important that the tubular structure has sufficient rigidity so that in use a stirring force may be applied thereto whilst the package is immersed in a liquid. The use of synthetic plastics materials, especially flexible web forms is preferred. Particularly preferred are webs formed from laminates, especially plastic film and aluminium laminates. An added benefit of using these materials is that heat transfer from hot or boiling water is restricted.

A wide variety of solid materials may be contained in the package of the invention. These solid materials may include certain powders, mixtures, composite materials, granules, beads, gels, pastes and creams of various kinds. The materials include coffee, such as coffee in freeze-dried and spray dried form, coffee mixes such as coffee and sugar (both natural and flavoured), coffee, sweetener and dairy creamer, carob, chicory, flavoured sugars, sweeteners, dairy mixes including infant formulas, salts, water purifiers, herbs, dry mix sports drinks, spices, tea and other food stuffs such as chocolate, caramel, malt, vanilla, fruit and natural and artificial flavourings and the like, and also flavour additives for alcoholic and non-alcoholic beverages. It may also include nutritional supplements such as vitamins and minerals as well as cosmetics, nutraceuticals, pharmaceutical, medicinal, veterinary, pharmaceutical, agricultural compositions. In addition, solid materials such as air-fresheners, effervescing solids and detergent compositions for washing clothes and dishes and cleaning purposes and the like may be used. An additional use is for dispensing Snus (Swedish tobacco) where the current package, made from filter paper is placed inside the upper lip of the user. The perforated package invention forms an alternative to this delivery form, enabling saliva to more readily enter and exit the package, while substantially retaining the contents inside the package.

In the agricultural market, there is also an application in seed propagation—where the package is used as a means of holding a seed with soil and fertilizer ready for planting, with the perforation holes used as a means of allowing moisture to penetrate the package, and in time root systems to move outwards through the package perforations. In this usage, the package would be constructed of an environmentally sensitive material that degrades over time.

In the pharmaceutical market, an important use is for antacids, allergy remedies, cough and cold remedies, analgesics, dietary products, vitamins and nutritional and vitamin supplements, including other OTC drug lines and prepared medicines.

Examples of liquids that are relevant to the present invention include hot water, for forming beverages such as coffee; cold or iced water for forming beverages such as ice tea; citrus drinks; hot and cold milk for forming beverages based on various flavourings including fruits, vanilla, malt, as well as fruit juices, and carbonated and non-carbonated beverages—both alcoholic and non-alcoholic. Non-beverage applications include the use of water, or milk, or juice in conjunction with pharmaceutical, medicinal, veterinary, pharmaceutical, agricultural and detergent compositions.

Filling of the solid material into the package of the invention may be accomplished by a variety of known machines. These include stick-pack machines made by Schwarze-Automation (Josef Blazek), Schmucker and Bosch in Europe; Toyo and Sanko machines made in Japan, Fres-Co System in the USA and others in India, Turkey and Italy. These machines may be configured as single or multi-lane machines.

As discussed above, preferably the tubular structure is formed from a printing web. In this preferred embodiment, the foraminous portion is formed by perforating each pack in a defined area, leaving other areas without perforations. There are a number of techniques for hole making or perforating packaging materials. These include hot and cold needle hole punching—where a series of holes is created by using a spiked wheel (cylinder) with needles to puncture the surface of the material. The needles punch or spike through the material with resistance given by a soft sheet (usually rubber) under the surface being punctured, or sometimes by a series of matching holes (mother father configuration). The needles may be cold, or hot (to create a larger hole).

Lasers have also been used to create perforation holes—where a laser beam is used (either as a single beam or split laser beam) to create a series of holes across a surface substrate. These are often computer controlled to enable the beam to be used in a precise manner.

Alternatively water jets may be used under pressure to cut holes, or the perforation holes may be created using a mechanical punch system (mother father die) to punch out holes in the web.

In the present invention it is preferred to use a mechanical die specially tooled with micron accuracy to stamp the holes in accurate placement across the web of material to create individual packages. The tool created is designed for mass-market production, with the wider the web, the bigger the tool, and the faster the operation. The size of the tool is to be configured to match the width and exact specifications of the Stick-pack machine being used, for example 1, 6, 12 or 24 lane machines. Later, the web is slit to make individual packages. This slitting of the printing web may be undertaken by the printer (example 24 lanes configured for 12 lane Stick-pack machine) and in turn slitting of the printing web into individual packages may be undertaken on the Stick-pack machine.

More particularly, it is preferred to use specialized hardened steel pins in a tool to stamp out the hole perforations in the web, with a 0.001 mm degree of accuracy in the tool making. The tool for this application is able to produce 24 patterned sets of perforations in one stamping operation with absolute accuracy. This means that the hole perforations on the left side of the printing web are identical in position and size to the hole perforations on the right side of the web, with no growth or movement in position at any time. Such tools and equipment to produce perforations of this placement accuracy are available from Wista GmbH, based in Schwaigern, Germany, and Charlotte, N.C., USA, who are able to create a precise, sectioned perforation pattern onto a printing web, using pre-printed eye-marks to register the position of the hole pattern, in relation to any printed advertising, branding, date coding or sealing areas.

Further, Wista are also able to add ‘visible security’ measures to the package—in the form of defined hole shapes and patterns of decoration. These holes may be round, oval, square or non-geometrical in shape, also with differing hole sizes, and in turn these holes placed in an overall pattern of holes to create both a functional, securitisation and decorative effect.

This hole patterning, and hole shaping enables packages so created to be traceable, and also adds an optical security defense against brand counterfeiting, providing another level of brand protection. This is becoming increasingly important in certain markets and product areas.

The solids package of the invention may be further packaged in multiple units using secondary packaging. Examples of such packaging include flow-wraps, cardboard cartons, vacuum trays, glass packaging and both flexible and hard plastic films and papers.

### BRIEF DESCRIPTION OF THE DRAWINGS

By way of example only, the invention is now described with reference to the accompanying drawings:

FIG. 1 is a front plan view according to one embodiment of the present invention;

FIG. 2 is a rear plan view according to one embodiment of the present invention;

FIG. 3 is a side plan view according to one embodiment of the present invention;

FIG. 4 is a top plan view according to one embodiment of the present invention;

FIG. 5 is a bottom plan view according to one embodiment of the present invention;

FIG. 6 is a front plan view according to a second embodiment of the present invention;

FIG. 7 is a rear plan view according to a second embodiment of the present invention;

FIG. 8 is a side plan view according to a second embodiment of the present invention;

FIG. 9 is a top plan view according to a second embodiment of the present invention;

FIG. 10 is a bottom plan view according to a second embodiment of the present invention;

FIG. 11 is a plan view of a first pattern of the foraminous portion of the present invention;

FIG. 12 is a plan view of a second pattern of the foraminous portion of the present invention;

FIG. 13 is a plan view of a third pattern of the foraminous portion of the present invention;

FIG. 14 is a plan view of a fourth pattern of the foraminous portion of the present invention; and

FIG. 15 is a detailed cross sectional view of an opening the foraminous portion of the present invention.

### DETAILED DESCRIPTION OF EXEMPLARY EMBODIMENTS OF THE INVENTION

Whilst the present invention will be described in relation to a solids package for containing freeze-dried or spray-dried coffee, it will be appreciated that it has application to a wide variety of other solid materials.

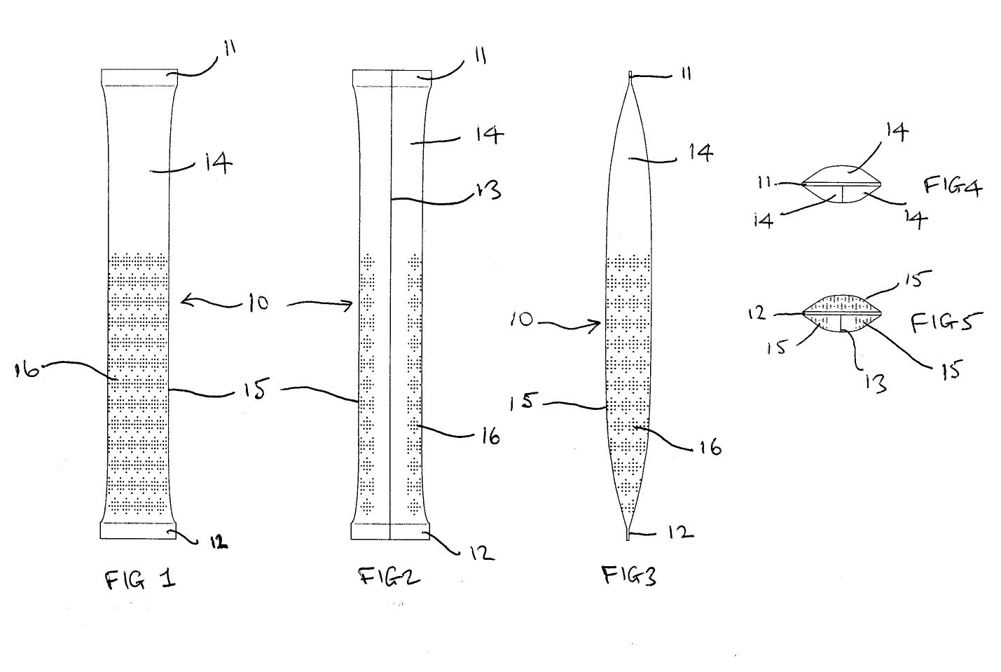

In FIGS. 1 to 5, there is shown one embodiment of the invention being a package 10 to contain freeze-dried or spray-dried coffee granules.

The package 10 comprises an elongate tubular structure 15 which is sealed at an upper end 11 and a lower end 12. Proximate the upper end 11, there is a gripping portion 14. Below the gripping portion 14 and distinct thereto is a foraminous portion 16.

The foraminous portion 16 comprises a diamond shaped pattern of perforations, about 1200, each circular and about 0.5 mm in diameter. The perforations 21 are best illustrated in FIG. 15.

As evident from FIG. 2, there is a seam 13 formed by two sides of a web being drawn together and sealed. The seam 13 extends the full length of the package. In this example, a lap-seal (closed seal) is used, but a fin-seal is also a possible alternative.

Overall, the tubular structure 15 is pillow-shaped in appearance with tapers towards each of the upper and lower ends.

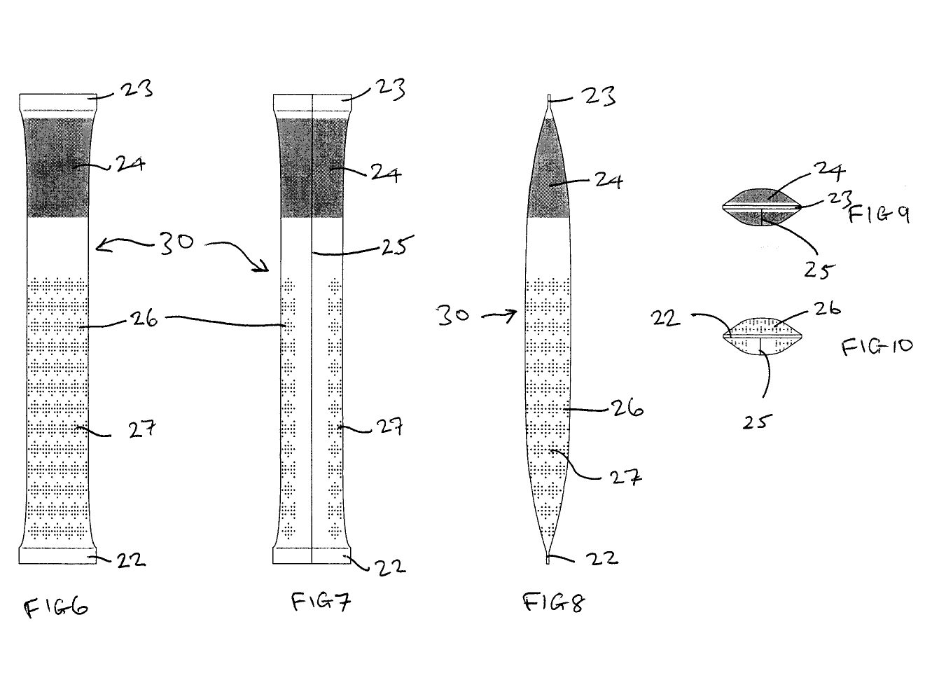

In FIGS. 6 to 10, there is shown a second embodiment of the invention being a package 30 to contain freeze-dried or spray-dried coffee granules.

The package 30 comprises an elongate tubular structure 26 which is sealed at an upper end 23 and a lower end 22. Proximate the upper end 23, there is a gripping portion 24. Below the gripping portion 24 and distinct thereto is a foraminous portion 26. In this embodiment, the gripping portion 24 includes printed material.

The foraminous portion 27 comprises a diamond shaped pattern of perforations, about 1200, each circular and about 0.5 mm in diameter. The perforations 21 are best illustrated in FIG. 15.

As evident from FIG. 7, there is a seam 25 formed by two sides of a web being drawn together and sealed as a lap-seal. The seam 25 extends the full length of the package.

Overall, the tubular structure 26 is pillow-shaped in appearance with tapers towards each of the upper and lower ends.

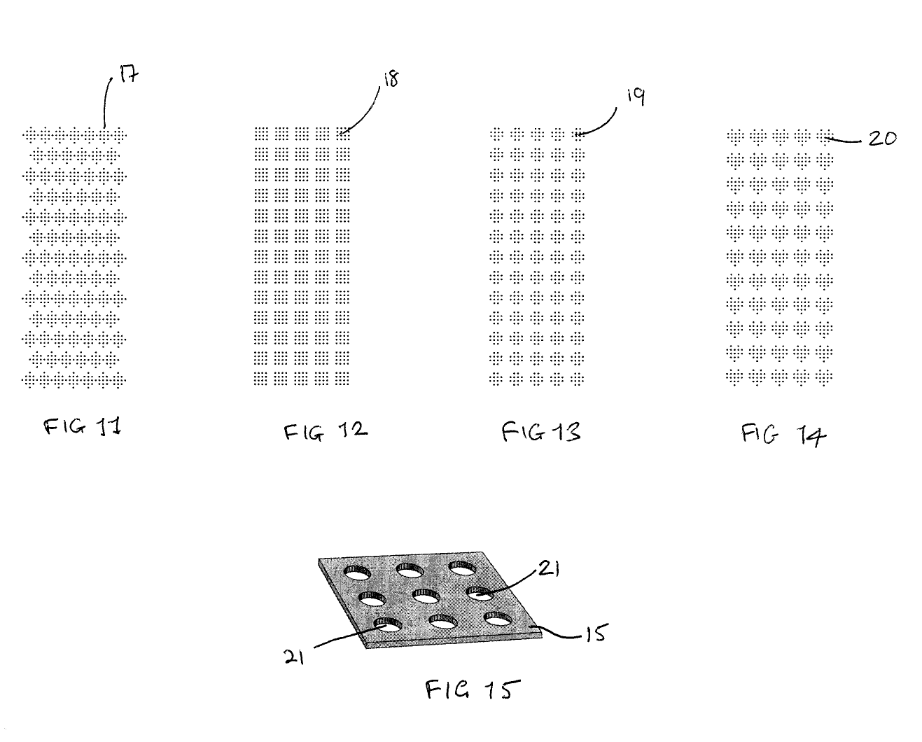

In FIGS. 11 to 14, there are shown a variety of alternative patterns for the foraminous portion. In FIG. 11, the pattern 17 is diamond shaped. In FIG. 12, the pattern 18 is square shaped. In FIG. 13, the pattern 19 is circular. In FIG. 14, the pattern 20 is heart shaped.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A solids package comprising a linear elongate tubular structure which is sealed at an upper end and a lower end thereof, the structure including an integral gripping portion proximate the upper end and a foraminous portion, a predetermined amount of a solid material contained within the tubular structure, the solid material having a particle size greater then the openings in the foraminous portion, the structure having sufficient overall rigidity so as to permit at least the foraminous portion to be immersed in a liquid and by holding the gripping portion, stirring the package so as to cause the solid material to be dispersed, dissolved, diffused or infused into the liquid.

2. The solids package of claim 1 in which the solid material is coffee, including freeze-dried and spray-dried coffee.

3. The solids package of claim 1 in which the solid material is a food selected from the group consisting of chocolate, chicory, sugars, salts, tea, herbs and spices.

4. The solids package of claim 1 in which the solid material is a pharmaceutical composition.

5. The solids package of claim 1 in which the solid material is a detergent composition.

6. The solids package of claim 1 in which the openings are at least about 0.2 mm in size.

7. The solids package of claim 1 in which the openings are about 0.4 to about 0.5 mm in size.

8. The solids package of claim 1 in which the openings are at no more then about 3.0 mm in size.

9. The solids package of claim 1 in which the foraminous portion is distinct from the gripping portion and comprises an array of openings.

10. The solids package of claim 9, the foraminous portion being comprised in a lower region of the structure.

11. A method of dissolving, dispersing, diffusing or infusing a predetermined amount of a solid material comprising:
immersing a package comprising a linearly elongate tubular structure which is sealed at an upper end and a lower end thereof, the structure including an integral gripping portion proximate the upper end and a foraminous portion, the solid material contained within the tubular structure, the solid material having a particle size greater then the openings in the foraminous portion, in liquid to an extent sufficient so that the foraminous portion is contact with the liquid,
applying a stirring force to the gripping portion for a time sufficient for the solid material to be dissolved, dispersed, diffused or infused into the liquid,
the structure retaining overall rigidity during the application of the stirring force.
